(19) United States
(12) Patent Application Publication
(10) Pub. No.: US 2017/0072380 A1
(43) Pub. Date: Mar. 16, 2017

(54) OPTIMIZED PACKING STRUCTURE FOR FLUID CONTACTING COLUMN AND MANUFACTURING METHOD

(71) Applicants: IFP Energies nouvelles, Rueil-Malmaison Cedex (FR); HERAKLES, LE HAILLAN (FR)

(72) Inventors: John ROESLER, VIENNE (FR); Alain LACOMBE, LE HAILLAN (FR)

(21) Appl. No.: 15/265,578

(22) Filed: Sep. 14, 2016

(30) Foreign Application Priority Data
Sep. 15, 2015 (FR) 15/58.652

(51) Int. Cl. B01J 19/32; B01D 53/18; B01D 53/14; C10L 3/10; B01J 20/20; B01J 20/26; B01J 20/282; B01J 20/30; B01D 3/28; B01J 20/28

(52) U.S. Cl. CPC B01J 19/32; B01D 3/28; B01D 53/185; B01D 53/1456; B01J 20/28052; B01J 20/28023; B01J 20/28059; B01J 20/20; B01J 20/26; B01J 20/282; B01J 20/3092; C10L 3/101; B01J 2220/82; B01J 2219/32279; B01J 2219/32408; B01J 2219/32425; B01J 2219/32483; B01J 2219/3306

(57) ABSTRACT

The present invention relates to a packing structure made up of an ordered arrangement of bundles of tubes (1). For each tube bundle, tubes (1) are oriented in the four directions formed by the diagonals of a rectangular parallelepiped having one dimension larger than the others.

### FIELD OF THE INVENTION

The present invention relates to the field of fluid contacting equipments.

The purpose of contacting columns is to provide contact between fluids in order to achieve matter or heat transfers between the fluids. This type of fluid contacting equipment is widely used to carry out distillation, rectification, absorption, heat exchange, extraction, chemical reaction operations, etc.

Contacting columns generally consist of an enclosure provided with internal contacting elements promoting exchange between the fluids. In general, the column allows to provide intimate contact between an ascending gas phase and a descending liquid phase, or vice versa. In the column, the fluids can circulate in a cocurrent or a countercurrent flow. The contacting elements that increase the contact surface between the fluids can be trays, a structured packing (i.e. the juxtaposition of several unitary elements, identical or not, arranged in an ordered manner, corrugated sheets for example) or a random packing (i.e. anarchic piles of unitary elements, for example rings, spirals).

### BACKGROUND OF THE INVENTION

Document EP-0,449,040 describes internal packing elements allowing to promote exchanges between fluids, to push back the fluid circulation block limits while providing increased resistance to chemical aggressions or corrosion.

In fluid contacting column applications, notably distillation or reactive absorption requiring washing a fluid with an absorbent solution, for example natural gas deacidizing or combustion fumes decarbonation, it is essential to have the best possible contacting elements providing a maximum contact surface while limiting pressure drops in the column and having maximum (liquid and gas) transfer coefficients.

Thus, patent FR-2,913,897 (U.S. Pat. No. 8,505,884) discloses an internal packing structure for a fluid contacting column well suited for distillation and reactive absorption applications, which notably allows the exchange surface between the fluids to be increased while limiting the pressure drop increase. The packing structure described in this patent is made up of an ordered arrangement of tube bundles, the tubes comprising orifices promoting exchanges. The tubes of each bundle are oriented in two directions or in four directions of a cube. However, the capacity of this packing structure remains low for the intended applications. The capacity of a packing corresponds to the amount of gas passing through a packing without flooding, i.e. without creating gas accumulations in a part of the packing.

The present invention thus relates to a packing structure made up of an ordered arrangement of tube bundles. For each tube bundle, the tubes are oriented in the four directions formed by the diagonals of a rectangular parallelepiped having one dimension larger than the others. Thus, this tube arrangement enables an inclination of the tubes on the column axis providing increased packing structure capacity.

### SUMMARY OF THE INVENTION

The invention relates to a packing structure for a fluid contacting column, said structure forming a volume comprising an ordered arrangement of tube bundles, the walls of said tubes comprising orifices provided so as to promote circulation and mixing of the fluids in said structure. Each bundle comprises four tubes respectively oriented in the four directions formed by the diagonals of a rectangular parallelepiped, said rectangular parallelepiped having one side dimension larger than the others.

According to the invention, the larger dimension of the rectangular parallelepiped is oriented in the vertical direction of said packing structure.

Advantageously, the angle of orientation of the axis of said tubes with respect to a vertical axis ranges between 20° and 50°, preferably between 30° and 45°.

Preferably, the hydraulic diameter of the tubes ranges between 5 and 50 mm.

According to an embodiment of the invention, said tubes have a substantially circular or elliptical section.

Advantageously, the section of said tubes is a polygon.

According to an embodiment of the invention, said structure comprises a plurality of parallelepipedic blocks made up of the ordered arrangement of tube bundles.

According to a characteristic, said orifices are inscribed in rectangles whose sides range between 2 and 45 mm, and each one of said orifices extends over a surface area greater than 2 mm².

According to a design of the invention, the ratio of the surface area of the orifices to the surface area of the solid part of said tubes ranges between 10% and 90%, preferably between 25% and 50%.

Preferably, said tubes comprise a cloth of at least two strips wound as two crossed helices extending along the same axis and with the same diameter, said strips being distant from one another so as to form said orifices.

According to an embodiment, said tubes consist of a plurality of rings connected by at least one rod, said rod being arranged along a generatrix of said tube.

According to a variant, said tubes are made of a material selected from among carbon congealed by carbon deposition, metal, ceramic, a polymer material or a thermoplastic material, a thermosetting material.

Furthermore, the invention relates to a fluid contacting column comprising a packing, said packing comprising a packing structure according to one of the above characteristics.

Besides, the invention relates to a use of a fluid contacting column according to the invention in a distillation process, a reactive absorption process, such as acid gas capture and natural gas treatment.

The invention also relates to a method of manufacturing a packing structure for a fluid contacting column, wherein the following stages are carried out:

a) manufacturing tubes comprising orifices arranged so as to promote circulation and mixing of the fluids in the structure,

b) constructing an ordered assembly of said tubes by juxtaposing bundles of tubes, said tube bundles comprising four tubes respectively oriented in the four directions formed by the diagonals of a rectangular parallelepiped, said rectangular parallelepiped having one dimension larger than the others, and

c) linking the tubes together at the contact portion thereof.

According to an embodiment, in stage a), tubes of circular or elliptical section are manufactured.

Alternatively, the section of said tubes is a polygon.

According to a variant embodiment, the larger dimension of said rectangular parallelepiped is oriented in the vertical direction of said packing structure.

According to a characteristic, said method comprises a stage of machining the ordered assembly so as to form rectangular parallelepiped blocks and a stage of laying out the blocks in said contacting column.

### BRIEF DESCRIPTION OF THE FIGURES

Other features and advantages of the method according to the invention will be clear from reading the description hereafter of embodiments given by way of non limitative example, with reference to the accompanying figures wherein:

FIG. 1 illustrates an example of a tube for a packing structure according to the invention,

FIG. 2 illustrates a second example of a tube for a packing structure according to the invention,

FIG. 3 shows a tube bundle for a packing structure according to the invention,

FIG. 4 shows a tube bundle arrangement for a packing structure according to the invention,

FIG. 5 illustrates a packing structure according to an embodiment of the invention,

FIG. 6 illustrates a third example of a tube for a packing structure according to the invention,

FIG. 7 is a view of the cross-sectional passage area for an elliptical tube in a tube bundle arrangement according to an embodiment of the invention,

FIG. 8 illustrates a section of an elliptical tube according to a variant embodiment of the invention,

FIG. 9 shows a contacting column comprising packing structure blocks according to an embodiment of the invention,

FIG. 10 shows the linear pressure drops for a 100 m³/h/m² wetting ratio for a packing structure according to the prior art and for a packing structure according to the invention, and

FIG. 11 shows the linear pressure drops for a 50 m³/h/m² wetting ratio for a packing structure according to the prior art and for a packing structure according to the invention.

### DETAILED DESCRIPTION

The present invention relates to a packing structure of a fluid contacting column. The packing structure according to the invention forms a volume comprising an ordered arrangement of tube bundles. A tube is understood to be a hollow cylinder of substantially constant section whose dimension perpendicular to the section (along the cylinder generatrix) is the largest dimension of the hollow element. A tube can have any section, for example square, rectangular, polygonal, circular, elliptical. According to the invention, the walls of the tubes comprise orifices arranged so as to promote circulation and mixing of the fluids in the structure.

According to the invention, each tube bundle comprises four tubes oriented in the four directions of the diagonals of a rectangular parallelepiped (or cuboid). Thus, the rectangular parallelepiped is not a cube and it therefore has one dimension larger than the other dimensions, which allows to reduce the angles of orientation of the tubes with respect to the vertical plane, because these angles are different from the angles formed by the directions of a cube. It is thus possible to increase the capacity of the packing structure. It is reminded that the capacity of a packing corresponds to the amount of gas passing through a packing without flooding, i.e. without creating gas accumulations in a part of the packing. The directions of the tubes substantially correspond to the four diagonals of a rectangular parallelepiped, except that the tubes do not intersect at the theoretical intersection of the diagonals at the center of the rectangular parallelepiped but in the vicinity of this point.

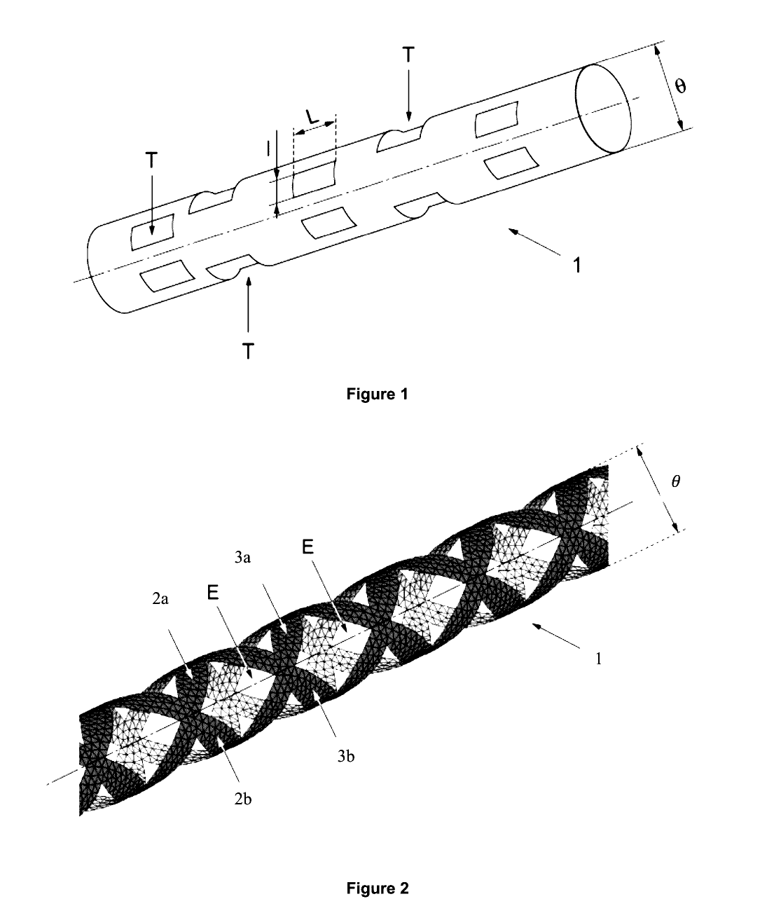

FIG. 1 shows by way of non limitative example an embodiment of a tubular element 1 forming the base pattern of a structured packing according to the invention. The tube of FIG. 1 is shown with a substantially circular section, the tube can however have a section of different shape: square, rectangle, polygon, circle, ellipse, etc. Any tube section shape is compatible with the various embodiments described below.

Element 1 consists of a wall in form of a tube of hydraulic diameter θ provided with orifices or holes T. The hydraulic diameter of a tube is a commonly used notation for calculating flows in a tube, a hydraulic pipe or a channel, so as to carry out similar calculations to those of a tube of circular section when the section of the tube is not circular. Hydraulic diameter θ can be defined with a formula of the type: θ=4A/P, with A the surface area of the cross-sectional passage of the tube and P the perimeter of the cross-sectional area of the tube. For a tube of circular section, the hydraulic diameter corresponds to the geometric diameter. According to the invention, the dimensions of orifices T and of hydraulic diameter θ are selected so as to optimize fluid circulation and contacting. According to an embodiment of the invention, hydraulic diameter θ of tubular element 1 ranges between 5 and 50 mm so as to optimize the geometrical area per unit of volume of a structured packing made up of such tubes. These dimensions allow to develop the geometrical area per unit of volume, while maintaining a low pressure drop, so as to be compatible with the intended applications.

According to an advantageous design of the invention, the minimum surface area of orifices T is selected greater than 2 mm², preferably 4 mm², so that the liquid film that flows within the tubes can be broken by a gas stream flowing through the orifices. Indeed, if the size of orifices T is smaller than 2 mm², the liquid film that circulates on the inner wall of a tube might clog these orifices through capillarity. The orifices having a surface area above 2 mm² allow passage of the gas and liquid phases from one tube to the other and thus provide proper contact and mixing. In the application of the packing according to the invention to reactive absorption, tubes provided with orifices whose surface area is greater than 4 mm² or even 8 mm² are preferably used. Indeed, in general, the fluids contacted in a reactive absorption column circulate at high rates, typically rates ranging between 1 m/s and 2 m/s. Larger orifices are therefore provided to fragment the liquid film circulating on the tube walls.

According to a variant embodiment of the invention, orifices T are inscribed in rectangles whose length L and width I range between 2 and 45 mm, preferably between 3 and 20 mm. In other words, an orifice must touch the four sides of a rectangle of length L and width I. On the other hand, an orifice T can have any shape provided that it remains inscribed in a rectangle of dimensions L and I. The orifice can have a substantially circular shape, the shape of an ellipse, the shape of a diamond. Inscribing the orifices in rectangles of dimensions L and I allows to impose a minimum dimension between the edges of the orifices in order to cause breaking of the liquid film circulating on the wall of the packing tubes.

Orifices T are arranged in an ordered or random manner. Preferably, orifices T are evenly arranged so as to obtain homogeneous exchange characteristics along element 1. Preferably, the space between two orifices does not exceed twice the value of hydraulic diameter θ. The number of orifices can be selected in such a way that element 1 comprises between 10% and 90% opening, i.e. the ratio of the surface area of the orifices to the surface area of the solid part of the tube ranges between 10% and 90%, an excellent value for this ratio ranging between 25% and 50%.

Orifices T as defined above open communication channels for the fluid between the inside and the outside of element 1 in order to optimize mixing between the phases, therefore contact and redistribution between the phases circulating in a structured packing made up of tubes 1.

Tubes 1 can be made of any type of material, carbon/carbon for example, i.e. a structure made of carbon fibers congealed by carbon deposition, ceramic, metal, polymer material, thermoplastic material or thermosetting material. Orifices T can be obtained through material removal, machining or boring for example. Element 1 can be obtained by molding, a polymer material for example, by forming or by any other process.

FIG. 2 illustrates a particular embodiment of element 1 of FIG. 1 obtained by braiding strips. The tube of FIG. 2 is shown with a substantially circular section; however, the tube can have a section of different shape: square, rectangle, polygon, circle, ellipse. Any tube section shape is compatible with the different variant embodiments described below.

According to the embodiment illustrated, tubular element 1 of FIG. 2 is made by weaving strips, for example yarns, threads, sheets, taking a tubular shape. More precisely, upon manufacture, a strip 2a is wound, by forming a helix, around a tube of hydraulic diameter θ. A second strip 2b is also wound, by forming a helix, around the same tube but crossed with respect to strip 2a. The thickness of the strips and the pitch of the helices are so selected as to leave spaces E between the strips. Preferably, the pitch of helix 2a is identical to the pitch of helix 2b. Spaces E fulfil the same purpose as orifices T of FIG. 1. The geometrical definitions of spaces E and of hydraulic diameter θ are respectively identical to those of orifices T and hydraulic diameter θ described in connection with FIG. 1.

Furthermore, in FIG. 2, the packing element comprises two additional strips 3a and 3b wound as helices respectively identical to those of strips 2a and 2b and axially offset. Thus, spaces E have substantially the shape of diamonds whose sides are materialized by strips 2a, 2b, 3a and 3b.

Without departing from the scope of the invention, tubular elements 1 can be made by varying different parameters, for example the number of strips, the thickness and the width of each strip, the pitch of the winding helix, or strips can be wound as variable-pitch helices.

Once winding of the strips is complete, the woven strip structure is congealed using for example a technique described in document EP-0,499,040, by thermal treatment, resin impregnation, gluing, welding or any other technique. For example, the strips are yarns made of glass or carbon fibers, possibly coated with a thermosetting material, a phenolic resin or an epoxy resin for example.

For all the embodiments of the invention, the tubes can be made with any type of material, carbon/carbon for example, i.e. a structure made of carbon fibers congealed by carbon deposition, ceramic, metal, polymer material, thermoplastic material or thermosetting material. The orifices can be obtained through material removal, machining or boring for example. Element 1 can be obtained by molding, a polymer material for example, by forming or by any other process.

According to the invention, each tube bundle comprises four tubes oriented in the four directions formed by the diagonals of a rectangular parallelepiped, the latter having at least one dimension (of one side) larger than the other dimensions (of the other sides) in order to increase the capacity of the packing structure. Thus, the tubes are positioned substantially in the direction of the four diagonals of a rectangular parallelepiped, except that the tubes do not intersect at the intersection of the diagonals at the center of the rectangular parallelepiped but in the vicinity of this point. The rectangular parallelepiped is so oriented that the larger dimension thereof (the length) is positioned substantially along the axis of the column in which it is inserted (direction of the gaseous and/or liquid flows), this axis is generally vertical. As a result of this tube arrangement and of the resulting inclination of the tubes with respect to the vertical plane, the capacity of the packing structure is increased.

According to an embodiment of the invention, the rectangular parallelepiped has a square base.

Advantageously, the angle formed by the axis of each tube with respect to a vertical axis, in a vertical plane passing through the axis of the tube, ranges between 20° and 55°, advantageously between 20° and 50°, to obtain a significant effect for the packing structure capacity. Preferably, this angle ranges between 30° and 45° for optimum results in terms of packing structure capacity.

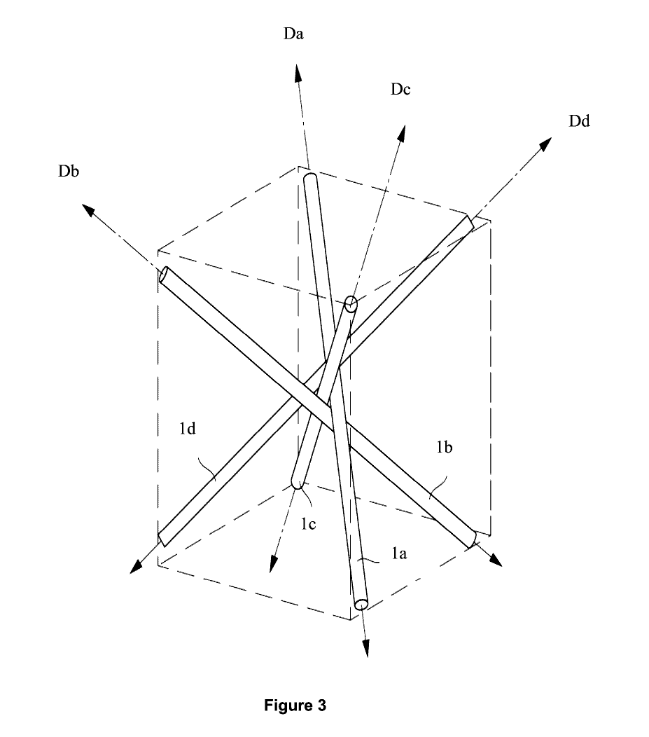

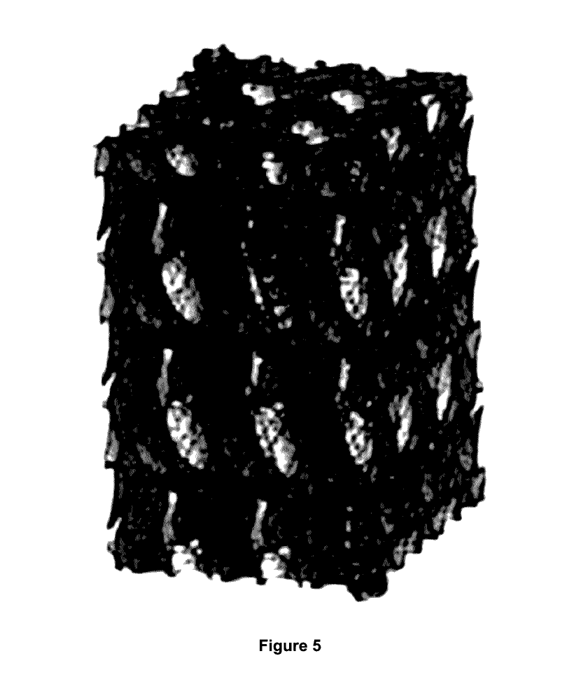

FIG. 5 shows an assembly of tubular elements according to the invention, the tubes being arranged in four distinct directions of a rectangular parallelepiped. The tubes of FIGS. 3 to 5 are shown with a substantially circular section, however the tubes can have a section of different shape: square, rectangle, polygon, circle, ellipse. Any tube section shape is compatible with the different variant embodiments described below.

The detailed layout of this assembly is described in connection with FIGS. 3, 4 and 5. FIG. 3 illustrates a bundle of four tubes 1a to 1d, each arranged in one of the four assembly directions Da to Dd. The four directions Da to Dd along which the tubes are assembled correspond respectively to the four diagonals of a rectangular parallelepiped, except that the tubes do not intersect at the level of the intersection of the diagonals at the center of the rectangular parallelepiped, they cross in the vicinity of this point.

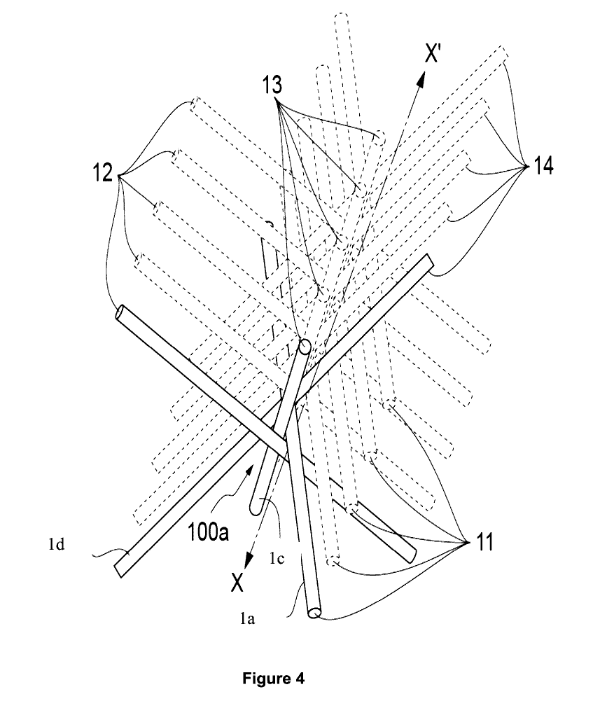

Construction of the ordered assembly can start for example by repeating the layout of FIG. 3, i.e. by arranging along a construction axis XX′ shown in FIG. 4, corresponding to the intersecting point of the four tubes of a bundle, a new bundle of tubes 1a to 1d arranged in the same order as the previous bundle, and so on. The start of an ordered assembly consisting of a first row 100a of bundles of tubes 1a to 1d aligned along the axis is thus obtained, as shown in FIG. 4. Four intertwined networks of tubes 11 to 14 extending each in a plane oriented in one of the four directions of assembly of the tubes in a bundle are thus formed. The tubes of each network are spaced out from one another by a distance allowing passage (intertwining) of the tubes of the other networks.

When the desired number of bundles is reached in row 100a, several series of rows of bundles are then superposed along axes parallel to axis XX′ so as to fill the free volume around row 100a. The packing structure is then obtained by adding an additional row of bundles along a new axis parallel to construction axis XX′. The free volume on either side of the row is then similarly completed, typically up to the end of the tubes of row 100a, so as to obtain in this volume a three-dimensional structure consisting of tubes respectively arranged in four directions.

According to a variant embodiment of the invention, in the tube assemblies described in connection with FIGS. 3 to 5, the tubes are connected to one another at the portions of contact between tubes. The connection can be achieved by means of a chemical or mechanical process, for example by means of a thermoplastic or thermosetting resin, by gluing, carbon deposition, welding, mechanical hooking or any other means.

According to an embodiment of the invention, the structured packing blocks can be machined to the dimensions and the shape of the contacting column. In general, contacting columns comprise a cylindrical enclosure. In this case, the ordered tube assembly is machined in order to obtain a packing structure of cylindrical shape that can be introduced into the cylindrical enclosure of the column so as to occupy maximum space in the column and thus to provide an optimum exchange surface.

For large-diameter columns, several blocks are juxtaposed. The blocks located on the inner periphery of the wall are machined to suit the cylindrical shape of the column. Machining the blocks made up of the assembly of tubular elements is very delicate considering the high intrinsic porosity of the construction. Depending on the nature of the materials, particular machining techniques are used to avoid buckling of the elements or collapse of the structure, for example laser machining, water jet machining or high speed machining.

Alternatively, the structured packing blocks can be cut or machined as rectangular parallelepiped blocks whose larger dimension is arranged, upon setting in a contacting column, parallel to the axis of the column, i.e. the vertical axis. The blocks can be arranged in successive sections, with no particular orientation of the base of the blocks from one section to the other. FIG. 5 is an example of a rectangular parallelepiped block that can be machined for this embodiment of the invention. FIG. 9 illustrates a non limitative example of layout of rectangular parallelepiped blocks 6 in a column 5. For this example, the blocks are distributed over two structured packing sections arranged one above the other.

According to an embodiment of the invention, the tube section has an elliptical shape. This elliptical shape of the tube section allows to obtain a solid arrangement of the tube bundles in the packing structure according to the invention (bundle of four tubes oriented in the four directions of the diagonals of a rectangular parallelepiped). Indeed, tubes of circular section are less suited for a solid arrangement in the case of a parallelepipedic structure. Furthermore, the arrangement of tubes of elliptical section allows to provide good tube spacing and provides contact points between the tubes. Advantageously, the geometry and the dimensions of the ellipse are related to the geometry and the dimensions of the rectangular parallelepiped.

Moreover, the geometric specificities described in connection with FIG. 1 (hydraulic diameter ranging between 5 and 50 mm, orifice surface area above 2 mm², orifices inscribed in a rectangle of length L and width I ranging between 2 and 45 mm, preferably between 3 and 20 mm) also apply to this embodiment (and for all the tube embodiments).

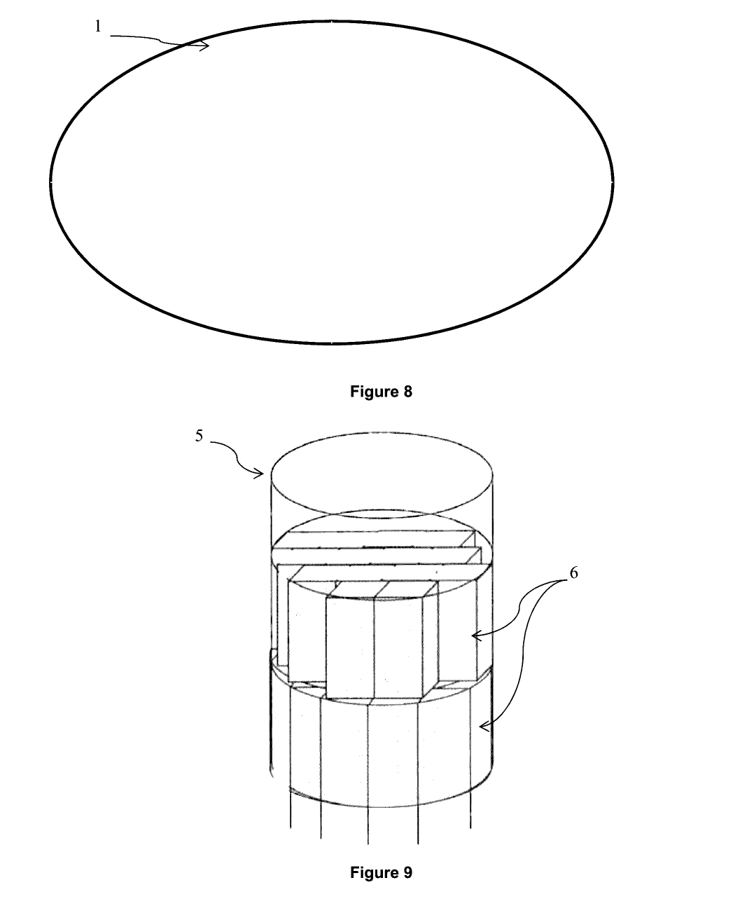

FIG. 8 shows an example of an elliptical section for a tube 1 of a structured packing according to the invention.

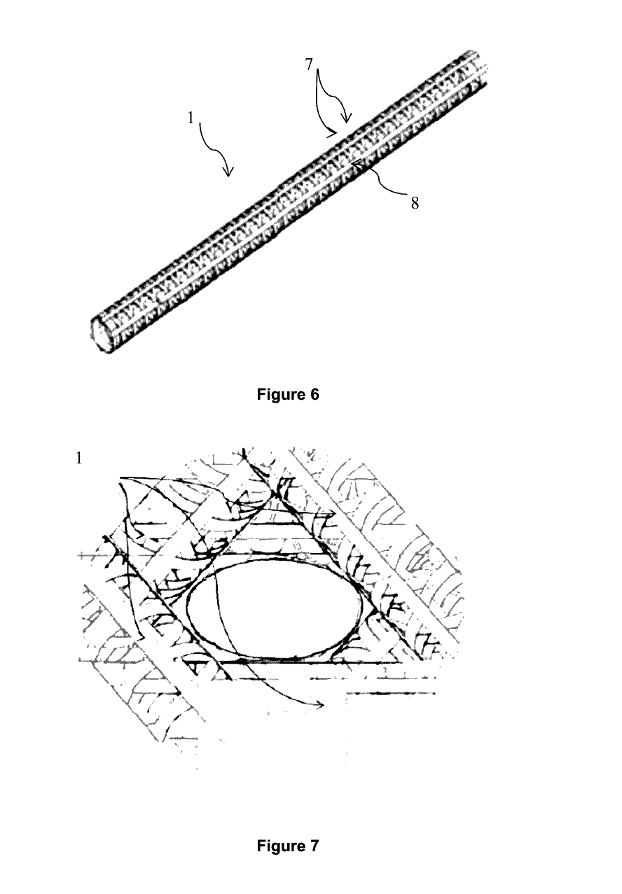

FIG. 6 shows an example of a tube 1 of polygonal section for a structured packing according to the invention. According to an embodiment of the invention, tube 1 illustrated here is made up of a set of rings 7 of polygonal shape, hexagonal here, connected by rods 8 parallel to the tube axis, and corresponding to generatrices of the tube. The spaces formed between the rings and the rods correspond to orifices T of the tubes.

FIG. 7 is a view of the cross-sectional passage area for a tube of elliptical section in an arrangement according to an embodiment of the invention. As illustrated, the tube arrangement is made up of tubes of elliptical section 1 according to an embodiment very close to the one described for FIG. 6. The central part of FIG. 7 corresponds to a space in which a tube 1 can be inserted.

The inner packing for contacting columns according to the present invention allows to obtain excellent results in distillation operations, notably for the preparation of fluorine derivatives requiring distillation in the presence of HF (hydrofluoric acid) or distillation of certain organic acids such as formic acid or acetic acid. It is also particularly well suited for reactive absorption applications, notably carbon dioxide capture in post-combustion and natural gas treatment, by contacting the gas with an absorbent liquid solution.

Furthermore, the present invention relates to a method of manufacturing a packing structure for a fluid contacting column. The manufacturing method allows to obtain a packing structure according to any one of the variant embodiments described above. The manufacturing method according to the invention comprises the following stages:

a) manufacturing tubes comprising orifices arranged so as to promote circulation and mixing of the fluids in the structure. The tubes can notably have the shape of a tube as illustrated in one of FIG. 1, 2 or 6. The tube can have a section of any shape: square, rectangle, polygon, circle, ellipse. For example, an elliptical section as illustrated in FIG. 8. The tubes can be made with any type of material, carbon/carbon for example, i.e. a structure made of carbon fibers congealed by carbon deposition, ceramic, metal, polymer material, thermoplastic material or thermosetting material.

For a tube according to the embodiment of FIG. 1, manufacturing can consist in first forming a solid tube, then in cutting out orifices at the desired points, for example by machining or boring. The tube can be obtained by moulding, a polymer material for example, by forming, or by any other process.

For a tube according to the embodiment of FIG. 2, manufacturing can consist in weaving strips, for example yarns, threads, sheets, taking a tubular shape. More precisely, a first strip can be wound, by forming a helix, around a tube, and a second strip can also be wound, by forming a helix, around the same tube but crossed with respect to the first strip. The thickness of the strips and the pitch of the helices are so selected as to leave spaces between the strips. The tube can be made up of several pairs of wound strips.

For a tube according to the embodiment of FIG. 6, manufacture thereof can comprise:
manufacturing rings of desired shape, polygon, circle, ellipse,
manufacturing rods, and
fastening the rods to the rings, the rods corresponding to the tube generatrix and the rings corresponding to the tube section. If the rings and the rods are made of metal, fastening can be achieved by welding. If the rings and the rods are made of a polymer material, fastening can be achieved by gluing or during the process of polymerization of the thermoplastic or thermosetting material.

b) An ordered assembly of tubes is then constructed by juxtaposing tube bundles. According to the invention, each tube bundle comprises four tubes respectively oriented in four directions of a rectangular parallelepiped, the rectangular parallelepiped having one dimension larger than the others. Preferably, the larger dimension of the parallelepiped corresponds to the vertical direction of the packing structure (see FIG. 3). The directions of a rectangular parallelepiped substantially correspond to the four diagonals of a rectangular parallelepiped, except that the tubes do not intersect at the intersection of the diagonals at the center of the rectangular parallelepiped, but in the vicinity of this point. This arrangement of the tubes allows the packing structure capacity to be increased.

Advantageously, the angle formed by the axis of each tube with respect to the horizontal plane, in a vertical plane passing through the axis of the tube, ranges between 20° and 54° in order to obtain a significant effect for the packing structure capacity. Preferably, this angle ranges between 30° and 45° so as to obtain optimum results in terms of packing structure capacity.

Construction of the ordered assembly can start for example by repeating the layout of FIG. 3, i.e. by arranging along a construction axis XX′, corresponding to the intersecting point of the four tubes of a bundle, a new bundle of tubes 1a to 1d arranged in the same order as the previous bundle, and so on. The start of an ordered assembly consisting of a first row 100a of bundles of tubes 1a to 1d aligned along construction axis XX′ is thus obtained, as shown in FIG. 4. Four intertwined networks of tubes 11 to 14 extending each in a plane oriented in one of the four directions of assembly of the tubes in a bundle are thus formed. The tubes of each network are spaced out from one another by a distance allowing passage (intertwining) of the tubes of the other networks.

When the desired number of bundles is reached in row 100a, several series of rows of bundles are then superposed along axes parallel to axis XX′ so as to fill the free volume around row 100a. The packing structure is then obtained by adding an additional row of bundles along a new axis parallel to construction axis XX′. The free volume on either side of the row is then similarly completed, typically up to the end of the tubes of row 100a, so as to obtain in this volume a three-dimensional structure consisting of tubes respectively arranged in four directions.

c) The next stage consists in connecting the tubes to one another so as to create a rigid arrangement. According to an embodiment of the invention, the tubes are connected at the portions of contact between tubes. The connection can be achieved by means of a chemical or mechanical process, for example by means of a thermoplastic or thermosetting resin, by gluing, carbon deposition, welding, mechanical hooking or any other means.

The manufacturing method according to the invention can then comprise one of stages d) or d′) described below, or a similar stage, allowing to provide the packing structure with a given shape.

d) According to an embodiment of the invention, the structured packing blocks can be machined to the dimensions and the shape of the contacting column. In general, contacting columns comprise a cylindrical enclosure. In this case, the ordered tube assembly is machined in order to obtain a packing structure of cylindrical shape that can be introduced into the cylindrical enclosure of the column so as to occupy maximum space in the column and thus to provide an optimum exchange surface.

d′) Alternatively, for large-diameter columns, several blocks are juxtaposed. The blocks located on the inner periphery of the wall are machined to suit the cylindrical shape of the column. Machining the blocks made up of the assembly of tubular elements is very delicate considering the high intrinsic porosity of the construction. Depending on the nature of the materials, particular machining techniques are used to avoid buckling of the elements or collapse of the structure, for example laser machining, water jet machining or high speed machining.

According to a variant of the invention, the structured packing blocks can be machined as rectangular parallelepiped blocks. The blocks are then arranged in a contacting column so that their lengths (the larger dimension) are parallel to the axis of the column, i.e. the vertical axis. The blocks can be arranged in successive sections, with no particular orientation from one section to the other. FIG. 5 is an example of a rectangular parallelepiped block that can be machined for this embodiment of the invention. FIG. 9 illustrates a non limitative example of layout of rectangular parallelepiped blocks 6 in a column 5. For this example, the blocks are distributed over two structured packing sections arranged one above the other.

### Comparative Example

A comparative example of the packing structure according to the invention and a packing structure according to the prior art with a tube bundle arrangement in the four directions of a cube (patent FR-2,913,897 (U.S. Pat. No. 8,505,884)) allows to show the gains in terms of pressure drop and therefore a capacity increase for the packing structure according to the invention.

The example consists in contacting in a column a liquid, water, with a gas, air, circulating in a countercurrent flow, by means of a structured packing.

For the two compared structured packing designs, the hydraulic diameter of the tubes is 12 mm, the tube opening ratio is 50%, the gas flow rate is constant at an absolute pressure of 1.5 bar and at ambient temperature, and the diameter of the column is 150 mm.

Furthermore, for the design according to the invention, the tubes have an elliptical section and the angle of the tubes with respect to a vertical axis is 30°.

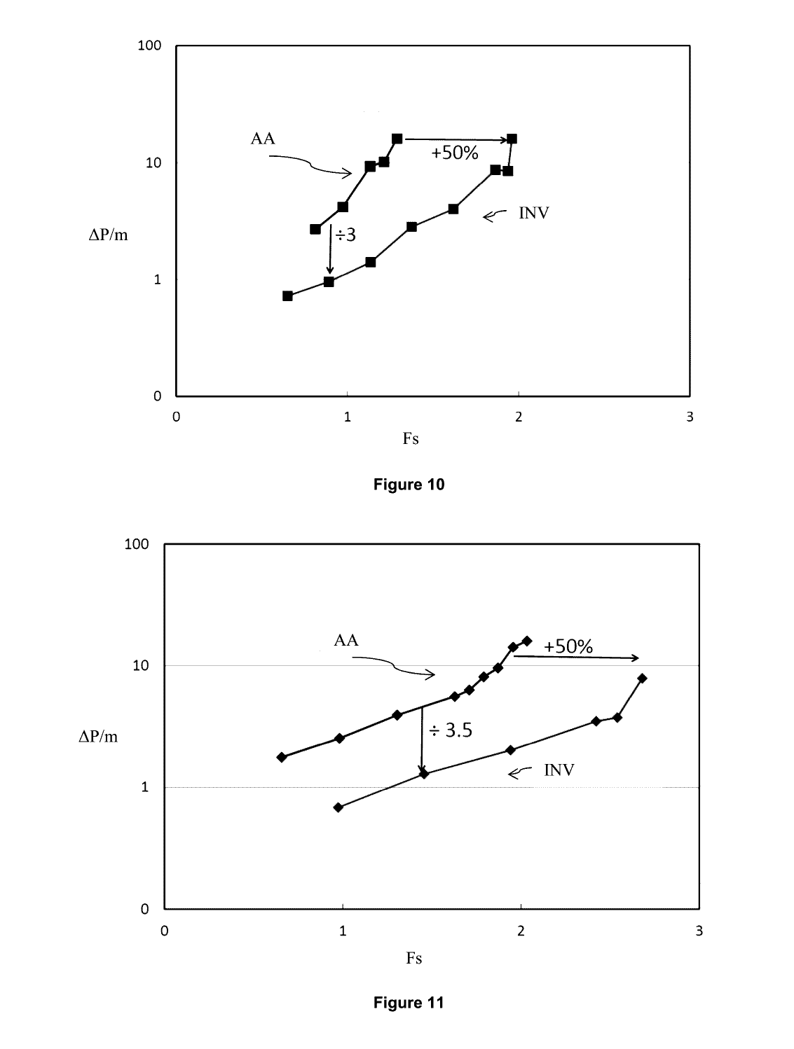

FIG. 10 shows the linear pressure drop ΔP/m expressed in mbar/mm as a function of the kinetic factor Fs expressed in √Pa for various configurations, including one with inclined tubes according to the prior art AA (patent FR-2,913,897) and the other at 30° according to the invention INV. The kinetic factor characterizes the kinetic energy of the gas in the packing. This value takes account of the effect of the pressure on the packing capacity. For the example of FIG. 10, the liquid flow rate is 100 m³/h/m². The capacity gain measured for this liquid flow rate is 50% and the linear pressure drop is reduced by a factor 3.

FIG. 11 is a curve identical to that of FIG. 10, for an example where the liquid flow rate is 50 m³/h/m². With this liquid flow rate, the variations are similar to those of the example illustrated in FIG. 10: a 50% capacity gain and a linear pressure drop decrease by a factor close to 3.5.

Thus, the packing structure according to the invention has an increased capacity in relation to the packing structure according to the prior art.

1. A packing structure for a fluid contacting column, said structure forming a volume comprising an ordered arrangement of bundles of tubes, the walls of said tubes comprising orifices provided so as to promote circulation and mixing of the fluids in said structure, characterized in that each bundle comprises four tubes respectively oriented in the four directions formed by the diagonals of a rectangular parallelepiped, said rectangular parallelepiped having one side dimension larger than the others.

2. A structure as claimed in claim 1, wherein the larger dimension of the rectangular parallelepiped is oriented in the vertical direction of said packing structure.

3. A structure as claimed in claim 1, wherein the angle of orientation of the axis of said tubes with respect to a vertical axis ranges between 20° and 50°, preferably between 30° and 45°.

4. A structure as claimed in claim 1, wherein hydraulic diameter of tubes ranges between 5 and 50 mm.

5. A structure as claimed in claim 1, wherein said tubes have a substantially circular or elliptical section.

6. A structure as claimed in claim 5, wherein the section of said tubes is a polygon.

7. A structure as claimed in claim 1, wherein said structure comprises a plurality of parallelepipedic blocks made up of the ordered arrangement of tube bundles.

8. A structure as claimed in claim 1, wherein said orifices are inscribed in rectangles whose sides range between 2 and 45 mm, and each one of said orifices extends over a surface area greater than 2 mm².

9. A structure as claimed in claim 1, wherein the ratio of the surface area of orifices to the surface area of the solid part of said tubes ranges between 10% and 90%, preferably between 25% and 50%.

10. A structure as claimed in claim 1, wherein said tubes comprise a cloth of at least two strips wound as two crossed helices extending along the same axis and with the same diameter, said strips being distant from one another so as to form said orifices.

11. A structure as claimed in claim 1, wherein said tubes consist of a plurality of rings connected by at least one rod, said rod being arranged along a generatrix of said tube.

12. A structure as claimed in claim 1, wherein said tubes are made of a material selected from among carbon congealed by carbon deposition, metal, ceramic, a polymer material or a thermoplastic material, a thermosetting material.

13. A fluid contacting column comprising a packing, characterized in that said packing comprises a packing structure as claimed in claim 1.

14. Use of a fluid contacting column as claimed in claim 13 in a distillation process, a reactive absorption process, such as acid gas capture and natural gas treatment.

15. A method of manufacturing a packing structure for a fluid contacting column, wherein the following stages are carried out:
a) manufacturing tubes comprising orifices arranged so as to promote circulation and mixing of the fluids in the structure,
b) constructing an ordered assembly of said tubes by juxtaposing bundles of tubes, said tube bundles comprising four tubes respectively oriented in the four directions formed by the diagonals of a rectangular parallelepiped, said rectangular parallelepiped having one dimension larger than the others, and
c) linking tubes together at the contact portion thereof.

16. A method as claimed in claim 15 wherein, in stage a), tubes of circular or elliptical section are manufactured.

17. A method as claimed in claim 16, wherein the section of said tubes is a polygon.

18. A method as claimed in claim 15, wherein the larger dimension of said rectangular parallelepiped is oriented in the vertical direction of said packing structure.

19. A method as claimed in claim 15, wherein said method comprises a stage of machining the ordered assembly so as to form rectangular parallelepiped blocks and a stage of laying out blocks in said contacting column.
